(19) United States
(12) Patent Application Publication
(10) Pub. No.: US 2021/0080567 A1
(43) Pub. Date: Mar. 18, 2021

(54) THROUGH-WALL RADAR SENSORS NETWORKED TOGETHER TO CREATE 2D AND 3D COMBINED VIEWS OF AN AREA

(71) Applicant: LUMINEYE, INC., Boise, ID (US)

(72) Inventors: Corbin Joseph Hennen, Boise, ID (US); Megan Aileen Lacy, Marlton, NJ (US); Robert M. Kleffner, Boise, ID (US)

(21) Appl. No.: 17/023,715

(22) Filed: Sep. 17, 2020

Related U.S. Application Data
(60) Provisional application No. 62/902,208, filed on Sep. 18, 2019.

(51) Int. Cl. G01S 13/88; H01Q 21/06; G01S 13/86; G01S 7/06; G01S 7/20; G01S 7/00

(52) U.S. Cl. CPC G01S 13/888; H01Q 21/061; G01S 13/867; G06F 3/14; G01S 7/20; G01S 7/003; G01S 7/06

(57) ABSTRACT

Systems and methods for networking together through-wall radar sensors to generate a combined image based on signal data from the networked through-wall radar sensors. The system includes a first through-wall radar sensor and a second through-wall radar sensor. The second through-wall radar sensor is networked with the first through-wall radar sensor. The system includes a display of an area, wherein the display of the area is based on data from the first through-wall radar sensor combined with data from the second through-wall radar sensor. The system may include a first communication device connected to the first through-wall radar sensor and a second communication device connected to the second through-wall radar sensor. A controller is networked with the first through-wall radar sensor and the second through-wall radar sensor. The system may include a plurality of through-wall radar sensors networked together to provide a two-dimensional or a three-dimensional image of an area.

### RELATED APPLICATION

This application claims the benefit of priority under 35 U.S.C. § 119 to U.S. Provisional Patent Application Ser. No. 62/902,208 entitled “NETWORKED THROUGH-WALL RADAR SENSORS TOGETHER TO CREATE 2D AND 3D COMBINED VIEWS OF THE AREA” filed on Sep. 18, 2019, which is incorporated herein in its entirety.

### FIELD OF THE DISCLOSURE

The examples described herein relate to systems and methods for networking together through-wall radar sensors to generate a combined image based on signal data from the networked through-wall radar sensors.

### BACKGROUND

### Description of the Related Art

First responders, military, and other personnel may need to determine the location of an individual or object located within a building or structure. Through-wall radar sensors may be used to determine if an individual is located within a building or structure. Present one-dimensional (1D) through-wall radar sensors may be used to detect an object through a wall and determine the distance to the object. 1D through-wall radar sensors are small and compact allowing them to be mobile. However, 1D through-wall radar sensors do not provide any angular resolution, which may be problematic in locating the object.

A two-dimensional (2D) through-wall radar sensor may be able to detect an object through a wall, determine the distance to the object, and determine what azimuth angle the object is relative to the sensor. A three-dimensional (3D) through-wall radar sensor may be able to detect an object through a wall, determine the distance to the object, determine what azimuth angle the object is relative to the sensor, and determine at what elevation angle the object is located at. However, 2D through-wall radar sensors and 3D through-wall radar sensors rely on antennas connected to the through-wall radar sensor with the resolution dependent upon spacing of the antennas. Antenna spacing of only a few feet apart make such systems too large and/or heavy to be mobile. First responders, and the like, do not have the time to set up such 2D or 3D through-wall radar sensors when attempting to locate an object and/or individual potentially located within a building or structure. Other disadvantages may exist.

### SUMMARY

The present disclosure is directed to systems and methods for networking together through-wall radar sensors to generate a combined image based on signal data from the networked through-wall radar sensors.

One example of the present disclosure is a system that includes a first through-wall radar sensor and a second through-wall radar sensor. The second through-wall radar sensor is networked with the first through-wall radar sensor. The system includes a display of an area, wherein the display of the area is based on data from the first through-wall radar sensor combined with data from the second through-wall radar sensor.

The display of the area may be a 2D display or a 3D display. The system may include a third through-wall radar sensor, wherein the third through-wall radar sensor is networked with the first through-wall radar sensor and the second through-wall radar sensor. The display of the area may be based on combined data from the first through-wall radar sensor, the second through-wall radar sensor, and the third through-wall radar sensor.

The display of the area may include data from a camera feed, a map, or a thermal image feed. The system may include an antenna array, wherein the antenna array is networked with the first through-wall radar sensor and the second through-wall radar sensor and wherein the display of the area is based on combined data from the first through-wall radar sensor, the second through-wall radar sensor, and the antenna array. The antenna array may be a 2D antenna array or may be a 3D antenna array. The system may include an ambient radio frequency signal, wherein the display of the area is further based on ambient radio frequency signal.

One example of the present disclosure is a system that includes a first through-wall radar sensor, the first through-wall radar sensor generates a first radar signal and a first communication device connected to the first through-wall radar sensor. The system includes a second through-wall radar sensor, the second through-wall radar sensor generates a second radar signal and a second communication device connected to the second through-wall radar sensor. The system includes a controller, wherein the controller is networked with the first through-wall radar sensor via the first communication device and is networked with the second through-wall radar sensor via the second communication device via the second communication device. The system includes a screen connected to the controller, wherein the screen displays an image of an object based on data from the first radar signal and data from the second radar signal.

The screen may be wirelessly connected to the controller. The image may be a 2D image. The controller may be integral to the first through-wall radar sensor. The system may include a third through-wall radar sensor, the third through-wall radar sensor generates a third radar signal and may include a third communication device connected to the third through-wall radar sensor. The controller may be networked with the third through-wall radar sensor via the third communication device. The screen may display the image of the object based on data from the first radar signal, data from the second radar signal, and data from the third radar signal. The image may be a 3D image.

The controller may be networked with the first through-wall radar sensor and the second through-wall radar sensor via a wired connection, wireless fidelity (Wi-Fi), Wi-Fi Direct, Bluetooth, Long-Term Evolution (LTE), fifth generation New Radio (5G-NR), or Ultra-Wideband (UWB). The first communication device may be a first mobile phone and the second communication device may be a second mobile phone. The data from the first radar signal may include detection data and ranging data and the data from the second radar signal may include detection data and ranging data. The system may include an ambient radio frequency signal, wherein the screen displays the image of the object further based on the ambient radio frequency signal.

One example of the present disclosure is a method for providing a network radar system. The method includes networking a first through-wall radar sensor to a second through-wall radar sensor and obtaining data from a first radar signal emitted from the first through-wall radar sensor. The method includes obtaining data from a second radar signal emitted from the second through-wall radar sensor and generating an image of an object based on data from the first radar signal and data from the second radar signal.

The image may be a 2D image. The method may include networking a third through-wall radar sensor with the first through-wall radar sensor and the second through-wall radar sensor. The method may include obtaining data from a third radar signal emitted from the third through-wall radar sensor. The method may include generating the image of the object based on data from the first radar signal, the second radar signal, and the third radar signal. The image may be a 3D image. The method may include receiving an ambient radio frequency signal and directing the first through-wall radar sensor and the second through-wall radar sensor to an area based on the ambient radio frequency signal.

### BRIEF DESCRIPTION OF THE DRAWINGS

FIG. 1 is a schematic of an embodiment of a system for networking together through-wall radar sensors to generate a combined image based on signal data from the networked through-wall radar sensors.

FIG. 2 is a schematic of an embodiment of a system for networking together through-wall radar sensors to generate a combined image based on signal data from the networked through-wall radar sensors.

FIG. 3 is a schematic of an embodiment of a system for networking together through-wall radar sensors to generate a combined image based on signal data from the networked through-wall radar sensors.

FIG. 4 is a schematic of an embodiment of a system for networking together through-wall radar sensors to generate a combined image based on signal data from the networked through-wall radar sensors.

FIG. 5 is a schematic of an embodiment of a system for networking together through-wall radar sensors to generate a combined image based on signal data from the networked through-wall radar sensors.

FIG. 6 is a schematic of an embodiment of a system for networking together through-wall radar sensors to generate a combined image based on signal data from the networked through-wall radar sensors.

FIG. 7 is a schematic of an embodiment of a system for networking together through-wall radar sensors to generate a combined image based on signal data from the networked through-wall radar sensors.

FIG. 8 is a schematic of an embodiment of a system for networking together through-wall radar sensors to generate a combined image based on signal data from the networked through-wall radar sensors.

FIG. 9 is a schematic of an embodiment of a two-dimensional display of an area.

FIG. 10 is a schematic of an embodiment of a system for networking together through-wall radar sensors to generate a combined image based on signal data from the networked through-wall radar sensors.

FIG. 11 is a schematic of an embodiment of a system for networking together through-wall radar sensors to generate a combined image based on signal data from the networked through-wall radar sensors.

FIG. 12 is a flow chart of an embodiment of a method for networking together through-wall radar sensors to generate a combined image based on signal data from the networked through-wall radar sensors.

FIG. 13 is a schematic of an embodiment of a three-dimensional display of an area.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure as defined by the appended claims.

### DETAILED DESCRIPTION

The present disclosure uses multiple one-dimensional through-wall radar sensors 10 that are networked together to create a 2D image or display or an area of interest or a 3D image or display of an area of interest. Networking the through-wall sensors 10 together enables a use to create a large virtual antenna array with 2D and/or 3D capabilities while using compact formfactor 1D through-wall radar sensors 10. As shown in the figures, multiple through-wall radar sensors 10 are designated with A, B, etc., for ease of distinguishing between the through-wall radar sensors 10. Further, while the sensors are referred to herein as through-wall sensors a wall or obstruction need not be present, and the sensors will function through air and the like. The through-wall radar sensors 10 may be networked in various ways including, but not limited to, having a wired connection between each device, a wireless connection, a radio link, via wireless fidelity (WiFi), via WiFi Direct, via Bluetooth, via Long-Term Evolution (LTE), via Ultra-wideband (UWB), via UWB radar, via fifth generation New Radio (5G-NR), and/or via a cellular network.

1D through-wall radar sensors 10 may be networked together to create a multi-monostatic radar. 1D through-wall radar sensors 10 may be networked together to create a bi-static or a multi-static radar. Two or more through-wall radar sensors 10 may be networked together to create a 2D radar system. Three or more through-wall radar sensors 10 may be networked together to create a 3D radar system. The networked 1D through-wall radar sensors 10 may be placed on perpendicular walls, parallel walls, the same wall, and/or be located in free space. The data from the signals of networked 1D through-wall radar sensors may be combined to create a map or display of an area. The map or display of an area may be 2D or may be 3D. The map or display of an area may be displayed on a screen or display of each of the networked through-wall radar sensors and/or may be viewed on a remote device via a wired or wireless connection.

Individual through-wall sensors 10 can be mounted, handheld and/or worn and still be networked together. Chest mounted 2D and 3D antenna arrays can also be networked together with other through-wall sensors 10. The through-wall sensors 10 being networked together can also combine and display other types of data and information such as, but not limited to, thermal imaging feeds, geographical maps, camera feeds, and/or the like.

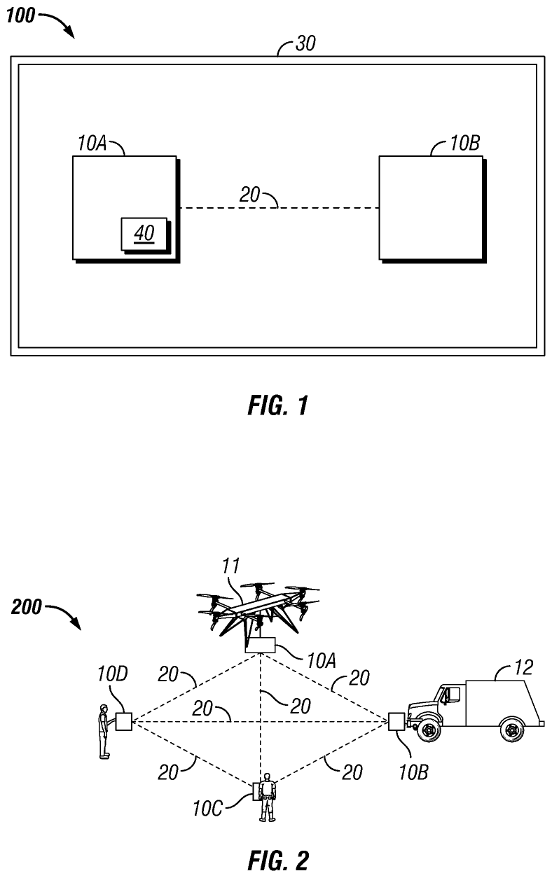

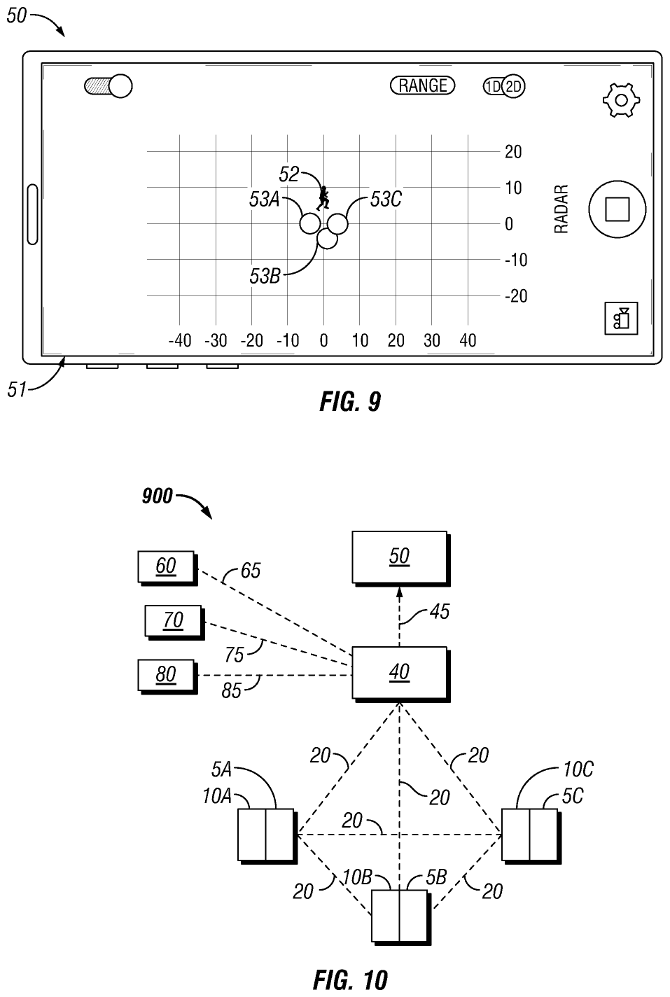

FIG. 1 is a schematic of a system 100 for networking together through-wall radar sensors 10A, 10B to generate a combined image based on signal data from the networked through-wall radar sensors 10A, 10B. The first through-wall radar sensor 10A may be used to detect an object through a barrier 30, such as a wall. The first through-wall radar sensor 10A is networked 20 with a second through-wall radar sensor 10B. The second through-wall radar sensor 10B may also be used to detect the object through the barrier 30. A controller 40 receives signals from the networked through-wall radar sensors 10A, 10B and uses data from the received signals to generate a display of an area. The display of the area is based on data from the signals received from the first through-wall radar sensor 10A combined with data from the signals received from the second through-wall radar sensor 10B. The controller 40 may be integral to one of the through-wall radar sensors. For example, the controller 40 may be integral to the first through-wall radar sensor 10A as shown in FIG. 1. In other embodiments, the controller 40 may be distinct and separately located from the through-wall radar sensors 10A, 10B. The display of the area may be shown on a display, or screen, 50 (shown in FIG. 9). The display 50 may be integral to one of the through-wall radar sensors 10A, 10B. Alternatively, the display 50 may be integral to the controller 40 or may be a distinct component.

The through-wall radar sensors 10 may be integrated with a cell phone. The cell phone may be used to network a plurality of through-wall radar sensors 10 together. The through-wall radar sensor 10 transmits a pulse, or signal, to scan an area of interest and obtains information on the scanned area based on the reflection received back from the through-wall radar sensor 10. The transmitted and received signal may provide data regarding detection of a target, person, or other object, as well as ranging information. The ranging information is information concerning the distance between two or more through-wall radar sensors 10. The data from the signals of networked through-wall radar sensors 10 may be used to provide a 2D and/or 3D display of an area. The display of the area may be used to locate a target, such as a person, located within the area of interest. Each through-wall radar sensor may transmit pulses at high frequencies to obtain data about an area of interest. For example, the through-wall radar sensors may transmit signals at, but not limited to 10 megahertz. A communication device connected to the through-wall radar sensor may be used to communicate the data from the through-wall radar sensor to a controller 40. For example, the through-wall radar sensor may be integrated with a cellular telephone or may be connected to a cellular telephone.

FIG. 2 is a schematic of a system 200 for networking together through-wall radar sensors 10A, 10B, 10C, 10D to generate a combined image based on signal data from the networked through-wall radar sensors 10A, 10B, 10C, 10D. A first through-wall radar sensor 10A may be connected to a remotely operated vehicle (ROV) 11, such as a drone, unmanned aircraft, or the like. A second through-wall radar sensor 10B may be connected to a vehicle 12. A third through-wall radar sensor 10C may be a chest mounted through-wall radar sensor. A fourth through-wall radar sensor 10D may be a handheld through-wall radar sensor. Each of the through-wall radar sensors 10A, 10B, 10C, 10D may be networked 20 together as discussed herein. The data from each of these sensors 10A, 10B, 10C, 10D may be combined to form a display of an area of interest as discussed herein. The number, configuration, and/or location of through-wall radar sensors may be varied as would be appreciated by one of ordinary skill in the art having the benefit of this disclosure.

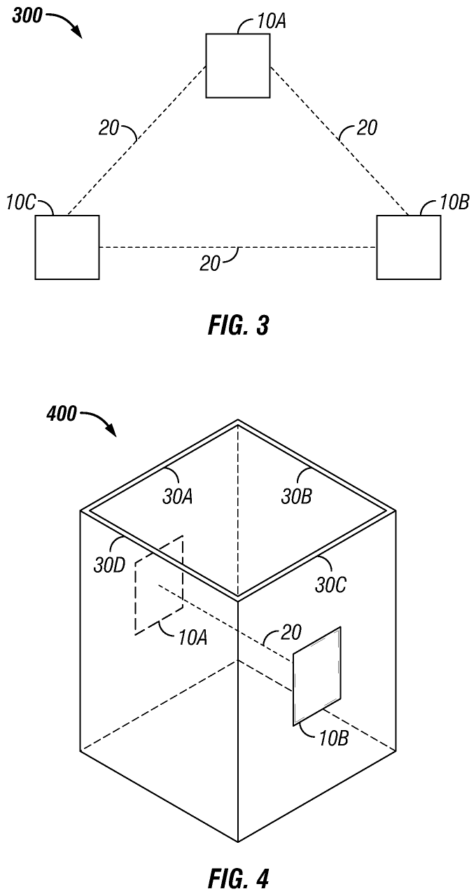

FIG. 3 is a schematic of a system 300 for networking together through-wall radar sensors 10A, 10B, 10C to generate a combined image based on signal data from the networked through-wall radar sensors 10A, 10B, 10C. The three through-wall radar sensors 10A, 10B, 10C are networked 20 together. The use of three or more networked through-wall radar sensors 10A, 10B, 10C enables the system 300 to generate a 3D map or display of an area of interest.

FIG. 4 is a schematic of a system 400 for networking together through-wall radar sensors 10A, 10B to generate a combined image based on signal data from the networked through-wall radar sensors 10A, 10B. The area of interest may include a plurality of walls 30A, 30B, 30C, 30D. The through-wall radar sensors 10A, 10B may be placed on parallel walls 30A, 30C. The through-wall radar sensors 10A, 10B are networked 20 so that the combined data from the signals from the through-wall radar sensors 10A, 10B may be used to display the area within the walls 30A, 30B, 30C, 30D.

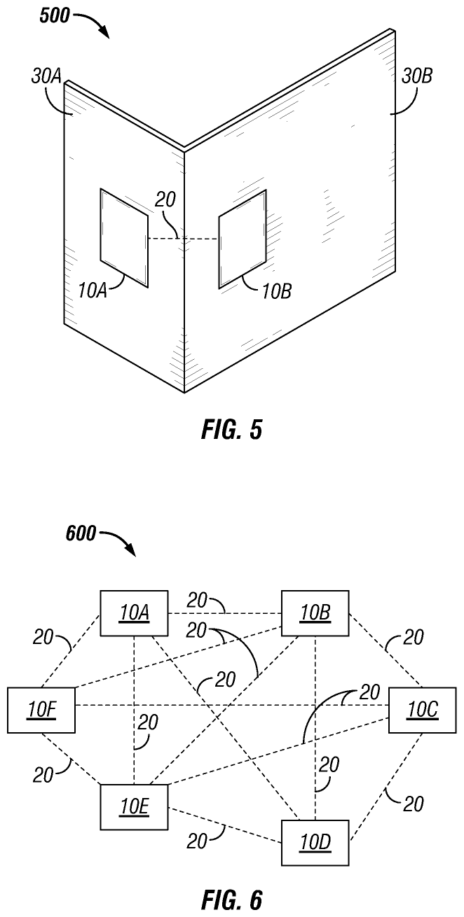

FIG. 5 is a schematic of a system 500 for networking together through-wall radar sensors 10A, 10B to generate a combined image based on signal data from the networked through-wall radar sensors 10A, 10B. The area of interest may include a plurality of walls 30A, 30B. The through-wall radar sensors 10A, 10B may be placed on perpendicular walls 30A, 30B. The through-wall radar sensors 10A, 10B are networked 20 so that the combined data from the signals from the through-wall radar sensors 10A, 10B may be used to display the area within the walls 30A, 30B.

FIG. 6 is a schematic of a system 600 for networking together through-wall radar sensors 10A, 10B, 10C, 10D, 10E, 10F to generate a combined image based on signal data from the networked through-wall radar sensors 10A, 10B, 10C, 10D, 10E, 10F. The through-wall radar sensors 10A, 10B, 10C, 10D, 10E, 10F may be networked 20 in various ways as disclosed herein. The through-wall radar sensors 10A, 10B, 10C, 10D, 10E, 10F may have various configurations. For example, the through-wall radar sensors 10A, 10B, 10C, 10D, 10E, 10F may be 1D through-wall radar sensors, 2D through-wall radar sensors, or 3D through-wall radar sensors. The through-wall radar sensors through-wall radar sensors 10A, 10B, 10C, 10D, 10E, 10F may be mounted on a ROV, mounted on a vehicle, located in free space, located on a structure such as a wall, handheld, or be chest mounted. The number of through-wall radar sensors through-wall radar sensors 10A, 10B, 10C, 10D, 10E, 10F may be more or less than six (6) as would be appreciated by one of ordinary skill in the art having the benefit of this disclosure.

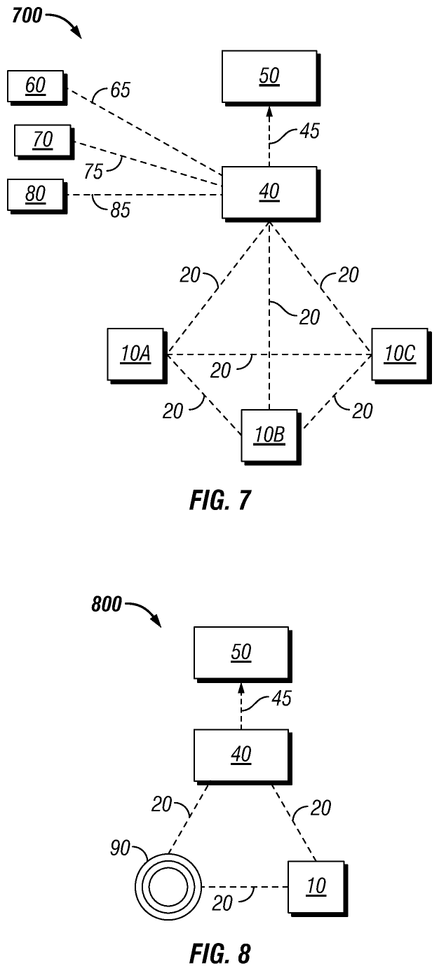

FIG. 7 is a schematic of a system 700 for networking together through-wall radar sensors 10A, 10B, 10C to generate a combined image based on signal data from the networked through-wall radar sensors 10A, 10B, 10C. The through-wall radar sensors 10A, 10B, 10C may be networked 20 in various ways as disclosed herein. The system 700 includes a controller 40 that is connected to each of the through-wall radar sensors 10A, 10B, 10C. The controller 40 combines data from the signals received from each of the through-wall radar sensors 10A, 10B, 10C to provide a display of an area of interest that may be viewed on display, or screen, 50. The display 50 is connected via connection 45 with the controller 40. The connection 45 may be wired or wireless as would be appreciated by one of ordinary skill in the art having the benefit of this disclosure. The display 50 and/or the controller 40 may be integral to one of the through-wall radar sensors 10A, 10B, 10C as would be appreciated by one of ordinary skill in the art having the benefit of this disclosure. For example, each of the through-wall sensors 10A, 10B, 10C may include an integral display 50 upon which the display of an area of interest may be shown.

The system 700 may utilize additional data sources regarding an area of interest. For example, a camera 60 (e.g., optical, infrared, ultraviolet, or the like) may provide data to the controller 40 via a connection 65. The data from the camera 60 may be combined with the data from the signals from the through-wall radar sensors 10A, 10B, 10C in forming the display of the area of interest. As another example, a mapping system 70 (e.g., global positioning systems “GPS” or the like) may provide data to the controller 40 via a connection 75. The data from the mapping system 70 may be combined with the data from the signals from the through-wall radar sensors 10A, 10B, 10C in forming the display of the area of interest. As yet another example, a thermal camera or imager 80 may provide data to the controller 40 via a connection 85. The data from the thermal camera or imager 80 may be combined with the data from the signals from the through-wall radar sensors 10A, 10B, 10C in forming the display of the area of interest. The controller 40 may use combine other sources of information with the data from the through-wall radar sensors 10A, 10B, 10C to create the display of an area as would be appreciated by one of ordinary skill in the art having the benefit of this disclosure.

FIG. 8 is a schematic of a system 800 for networking together 20 through-wall radar sensors 10 with an ambient radio frequency signal 90 to generate a combined image based on signal data from the networked 20 through-wall radar sensors 10 and the ambient radio frequency signal 90. The ambient radio frequency signal 90 may be any radio frequency signal, such as, but not limited to, to a WiFi signal, wireless network, and/or a cellular network. FIG. 8 shows a single through-wall radar sensor 10 networked 20 with the ambient radio frequency signal 90 for clarity. The system 800 may include one or more through-wall radar sensors 10 may be networked 20 with the ambient radio frequency signal 90 as would be appreciated by one of ordinary skill in the art having the benefit of this disclosure.

The ambient radio frequency signal 90 may be used to determine the presence of a target, or the like, in a general area. For example, the movement of a target may cause a detectable disturbance in an ambient radio frequency signal 90. The detected disturbance may be communicated to the controller 40 via network 20. The controller 40 may then focus the one or more through-wall radar sensors 10 to scan and/or focus on the area of interest where the disturbance was detected. The ambient radio frequency signal 90 may be helpful in limiting the search of a target within a large structure such as a building. The ambient radio frequency signal 90 may be used by the controller 40 of the system 800 to focus on a particular area or quadrant of the structure.

FIG. 9 shows a monitor, or screen, 50 displaying a two-dimensional display 51 of an area. The display 51 indicates the location of a target 52 with respect to the location 53A of a first through-wall radar sensor, the location 53B of a second through-wall radar sensor, and the location 53C of a third through-wall radar sensor. The display 51 may be used to efficiently locate the target 52 within a structure and/or a building. The monitor, or screen, 50 may be remotely located from the through-wall radar sensors 10 as discussed herein. In such an instance, the location may be communicated to personnel located near the target to aid in locating the target. The location may be communication to personnel in various ways. For example, the location may be transmitted to a viewing device such as a augmented reality headset or device utilized by personnel. As disused herein, one or more of the through-wall radar sensors 10 may include the monitor or screen 50.

FIG. 10 is a schematic of a system 900 for networking together through-wall radar sensors 10A, 10B, 10C to generate a combined image based on signal data from the networked through-wall radar sensors 10A, 10B, 10C. The through-wall radar sensors 10A, 10B, 10C may be networked 20 in various ways as disclosed herein. The first through-wall radar sensor 10A includes a first communication device 5A connected to the first through-wall radar sensor 10A. For example, the first communication device 5A may be, but is not limited to, a cellular phone. The second through-wall radar sensor 10B includes a second communication device 5B connected to the second through-wall radar sensor 10B. For example, the second communication device 5B may be, but is not limited to, a cellular phone. The third through-wall radar sensor 10C includes a third communication device 5C connected to the third through-wall radar sensor 10C. For example, the third communication device 5C may be, but is not limited to, a cellular phone. The first, second, and third communication devices 5A, 5B, 5C may be used to network the first, second, third through-wall radar sensors 10A, 10B, 10C and the controller 40 together. As discussed herein, the through-wall radar sensors may be integrated into a cellular telephone. Likewise, the controller 40 may be remote or may be directly connected to or integrated within one of the through-wall radar sensors.

The system 900 includes a controller 40 that is connected to each of the through-wall radar sensors 10A, 10B, 10C. The controller 40 combines data from the signals received from each of the through-wall radar sensors 10A, 10B, 10C to provide a display of an area of interest that may be viewed on display, or screen, 50. The display 50 is connected via connection 45 with the controller 40. The connection 45 may be wired or wireless as would be appreciated by one of ordinary skill in the art having the benefit of this disclosure. The display 50 and/or the controller 40 may be integral to one of the through-wall radar sensors 10A, 10B, 10C as would be appreciated by one of ordinary skill in the art having the benefit of this disclosure. For example, each of the through-wall sensors 10A, 10B, 10C may include an integral display 50 upon which the display of an area of interest may be shown.

The system 700 may utilize additional data sources regarding an area of interest. For example, a camera 60 (e.g., optical or otherwise) may provide data to the controller 40 via a connection 65. The data from the camera 60 may be combined with the data from the signals from the through-wall radar sensors 10A, 10B, 10C in forming the display of the area of interest. As another example, a mapping system 70 (e.g., GPS or otherwise) may provide data to the controller 40 via a connection 75. The data from the mapping system 70 may be combined with the data from the signals from the through-wall radar sensors 10A, 10B, 10C in forming the display of the area of interest. As yet another example, a thermal camera or imager 80 may provide data to the controller 40 via a connection 85. The data from the thermal camera or imager 80 may be combined with the data from the signals from the through-wall radar sensors 10A, 10B, 10C in forming the display of the area of interest. The controller 40 may use combine other sources of information with the data from the through-wall radar sensors 10A, 10B, 10C to create the display of an area as would be appreciated by one of ordinary skill in the art having the benefit of this disclosure.

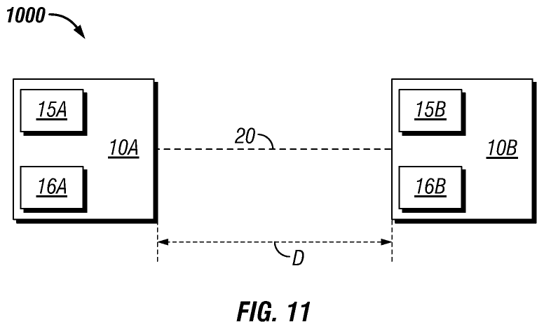

FIG. 11 is a schematic of a system 1000 for networking together through-wall radar sensors 10A, 10B to generate a combined image based on signal data from the networked through-wall radar sensors 10A, 10B. The through-wall radar sensors 10A, 10B may be networked 20 in various ways as disclosed herein. The first through-wall radar sensor 10A includes a transmit antenna 15A and a receive antenna 16A. Likewise, the second through-wall radar sensor 10B include a transmit antenna 15B and a receive antenna 16B. The first through-wall radar sensor 10A may be located a known distance D from the second through-wall radar sensor 10B. The known distance D between the two through-wall radar sensors 10A, 10B may be used by a controller 40 (not shown in FIG. 11) when combining the data from signals received from the through-wall radar sensors 10A, 10B when generating a display 51 of a scanned area.

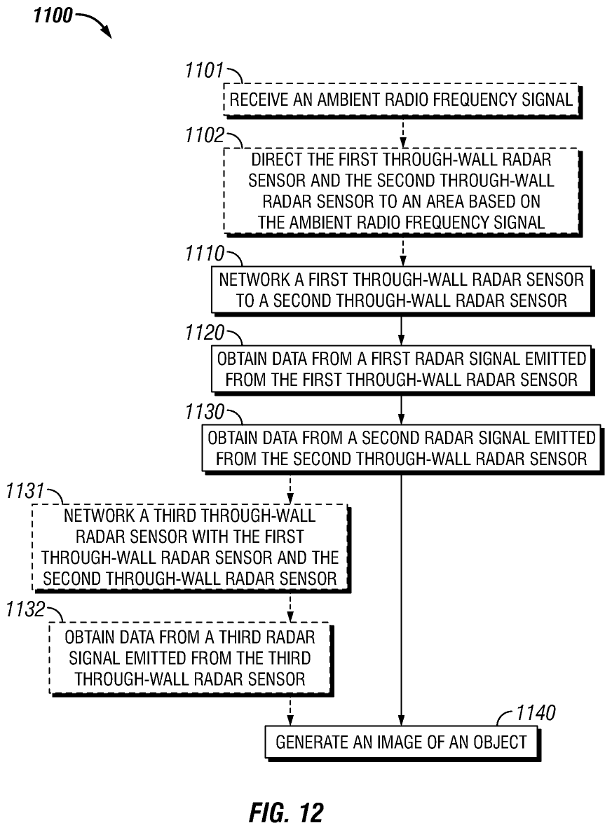

FIG. 12 is a flow chart of an embodiment of a method 1100 for networking together through-wall radar sensors to generate a combined image based on signal data from the networked through-wall radar sensors 10. The method 1100 includes networking a first through-wall radar sensor to a second through-wall radar sensor, at 1110. The first through-wall radar sensor may be networked to the second through-wall radar sensor in various ways as disclosed herein. The method 1100 includes obtaining data from a first radar signal emitted from the first through-wall radar sensor, at 1120. The method 1100 includes obtaining data from a second radar signal emitted from the second through-wall radar sensor, at 1130. The method 1100 includes generating an image (e.g., display 51) of an object, at 1140. For example, the data from the first radar signal may be combined with the data from the second radar signal to determine if an object is located within an area of interest. The data may be used to generate a map or display of an area showing an object located within the area.

The method 1100 may include receiving an ambient radio frequency signal, at 1101, and directing the first through-wall radar sensor and the second through-wall radar sensor to an area based on the ambient radio frequency signal, at 1102. For example, an ambient radio frequency signal 90 may be used to determine the presence of a target in a general area. The movement of a target may cause a detectable disturbance in an ambient radio frequency signal 90. The detected disturbance may be communicated to the controller 40 via network 20. The controller 40 may then focus the one or more through-wall radar sensors 10 to scan and/or focus on the area of interest where the disturbance was detected. The ambient radio frequency signal 90 may be helpful in limiting the search of a target within a large structure such as a building. The ambient radio frequency signal 90 may be used by the controller 40 of the system 800 to focus on a particular area or quadrant of the structure.

The method 1100 may include networking a third through-wall radar sensor with the first through-wall radar sensor and the second through-wall radar sensor, at 1131. The method 1100 may also include obtaining data from a third radar signal emitted from the third through-wall radar sensor, at 1132. The step of generating an image of an object, at 1140, may be based on the data from the first radar signal combined with the data from the second radar signal and the third radar signal to determine if an object is located within an area of interest. The data may be used to generate a map or display of an area showing an object located within the area. The map or display may be a 3D display of the area. The method 1100 may include combining data from more than three through-wall radar sensors as would be appreciated by one of ordinary skill in the art having the benefit of this disclosure.

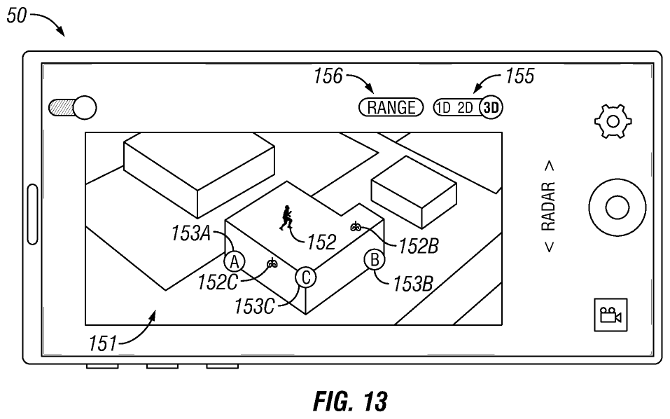

FIG. 13 shows a monitor, or screen, 50 displaying a three-dimensional display 151 of an area. The display 151 indicates the location of a first target 152A, second target 152B, and third target 152C with respect to the location 153A of a first through-wall radar sensor, the location 153B of a second through-wall radar sensor, and the location 153C of a third through-wall radar sensor. The first target 152A may be person in motion. The second target 152B and the third target 152C may be the detection of the location of persons breathing within the scanned area. The display 151 may be used to efficiently locate targets 152A, 152B, 152C within a structure and/or a building. The monitor, or screen, 50 may be remotely located from the through-wall radar sensors 10 as discussed herein. In such an instance, the location may be communicated to personnel located near the target to aid in locating the target. Alternatively, one or more of the through-wall radar sensors 10 may include the monitor or screen 50. The monitor 50 may include a first user input 155 that enables the display 151 to change between a one-dimensional view, a two-dimensional view, and a three-dimensional view of an area scanned by one or more through-wall radar sensors 10. The monitor 50 may also include a second user input 156 that enables the system to recalibrate the ranges between one or more through-wall radar sensors 10.

Although this disclosure has been described in terms of certain embodiments, other embodiments that are apparent to those of ordinary skill in the art, including embodiments that do not provide all of the features and advantages set forth herein, are also within the scope of this disclosure. Accordingly, the scope of the present disclosure is defined only by reference to the appended claims and equivalents thereof

What is claimed is:

1. A system comprising:
a first through-wall radar sensor;
a second through-wall radar sensor, wherein the second through-wall radar sensor is networked with the first through-wall radar sensor; and
a display of an area, wherein the display of the area is based on data from the first through-wall radar sensor combined with data from the second through-wall radar sensor.

2. The system of claim 1, wherein the display of the area is a two-dimensional display.

3. The system of claim 1, wherein the display of the area is a three-dimensional display.

4. The system of claim 1, comprising a third through-wall radar sensor, wherein the third through-wall radar sensor is networked with the first through-wall radar sensor and the second through-wall radar sensor and wherein the display of the area is based on combined data from the first through-wall radar sensor, the second through-wall radar sensor, and the third through-wall radar sensor.

5. The system of claim 1, wherein the display of the area includes data from a camera feed, a map, or a thermal image feed.

6. The system of claim 1, comprising an antenna array, wherein the antenna array is networked with the first through-wall radar sensor and the second through-wall radar sensor and wherein the display of the area is based on combined data from the first through-wall radar sensor, the second through-wall radar sensor, and the antenna array.

7. The system of claim 6, wherein the antenna array is a 2D antenna array.

8. The system of claim 6, wherein the antenna array is a 3D antenna array.

9. The system of claim 1, further comprising an ambient radio frequency signal, wherein the display of the area is further based on ambient radio frequency signal.

10. A system comprising:
a first through-wall radar sensor, the first through-wall radar sensor generates a first radar signal;
a first communication device connected to the first through-wall radar sensor;
a second through-wall radar sensor, the second through-wall radar sensor generates a second radar signal;
a second communication device connected to the second through-wall radar sensor;
a controller, wherein the controller is networked with the first through-wall radar sensor via the first communication device and is networked with the second through-wall radar sensor via the second communication device via the second communication device; and
a screen connected to the controller, wherein the screen displays an image of an object based on data from the first radar signal and data from the second radar signal.

11. The system of claim 10, wherein the screen is wirelessly connected to the controller.

12. The system of claim 10, wherein the controller is integral to the first through-wall radar sensor.

13. The system of claim 10, comprising:
a third through-wall radar sensor, the third through-wall radar sensor generates a third radar signal;
a third communication device connected to the third through-wall radar sensor;
wherein the controller is networked with the third through-wall radar sensor via the third communication device; and
wherein the screen displays the image of the object based on data from the first radar signal, data from the second radar signal, and data from the third radar signal.

14. The system of claim 13, wherein the image is a three-dimensional (3D) image.

15. The system of claim 10, wherein the controller is networked with the first through-wall radar sensor and the second through-wall radar sensor via a wired connection, a wireless connection, a radio link, wireless fidelity (Wi-Fi), Wi-Fi Direct, Bluetooth, Long-Term Evolution (LTE), 5G-NR, or Ultra-Wideband (UWB).

16. The system of claim 10, wherein the first communication device is a first mobile phone and wherein the second communication device is a second mobile phone.

17. The system of claim 10, wherein the data from the first radar signal includes detection data and ranging data and wherein the data from the second radar signal includes detection data and ranging data.

18. The system of claim 10, further comprising an ambient radio frequency signal, wherein the screen displays the image of the object further based on the ambient radio frequency signal.

19. A method for providing a network radar system, the method comprising:
networking a first through-wall radar sensor to a second through-wall radar sensor;
obtaining data from a first radar signal emitted from the first through-wall radar sensor;
obtaining data from a second radar signal emitted from the second through-wall radar sensor; and
generating an image of an object based on data from the first radar signal and data from the second radar signal.

20. The method of claim 19, further comprising:
networking a third through-wall radar sensor with the first through-wall radar sensor and the second through-wall radar sensor;
obtaining data from a third radar signal emitted from the third through-wall radar sensor; and
generating the image of the object based on data from the first radar signal, the second radar signal, and the third radar signal.

21. The method of claim 19, further comprising:
receiving an ambient radio frequency signal; and
directing the first through-wall radar sensor and the second through-wall radar sensor to an area based on the ambient radio frequency signal.
